(19) United States
(12) Patent Application Publication
(10) Pub. No.: US 2008/0014074 A1
(43) Pub. Date: Jan. 17, 2008

(54) Off-the-bottom Depalletizer apparatus and method

(76) Inventor: Lorin Reed, Kingsburg, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/827,719

(22) Filed: Jul. 12, 2007

Related U.S. Application Data
(60) Provisional application No. 60/807,228, filed on Jul. 13, 2006.

(51) Int. Cl. B65G 59/00; B65G 61/00

(52) U.S. Cl. 414/796.2; 414/801

(57) ABSTRACT

A depalletizer for removing articles stacked on a pallet that removes the pallet from the below the stack of articles and then removes layers of the stack from the bottom. The depalletizer comprises a receiving section that transfers the loaded pallet to a support structure in a load separating section. The support structure has a chain conveyor and perpendicularly disposed roller conveyor and a clamping mechanism configured to clamp layers of the stack. The clamping mechanism clamps the bottom layer of the stack, the support structure lowers to separate the pallet and the chain conveyor transports the pallet away. The support structure moves up to support the stack and then is lowered to reclamp at the layer above the bottom layer. The support structure lowers again to separate the bottom layer from the stack and the roller conveyor transports it away. The process is repeated until the stack is empty.

### CROSS-REFERENCE TO RELATED APPLICATIONS

This application claims the benefit of U.S. Provisional Patent Application No. 60/807,228 filed Jul. 13, 2006.

### BACKGROUND OF THE INVENTION

A. Field of the Invention

The field of the present invention relates generally to apparatuses and methods for removing articles from a stack of articles on a pallet or other load bearing structure. More particularly, the present invention relates to such apparatuses and methods that are configured to unstack or depalletize articles from a pallet by separating the pallet from the stack and then removing a layer of articles from the bottom of the stack of articles.

B. Background

A wide variety of articles are delivered to warehouses, processing plants, stores or like facilities on pallets or other load bearing structures for removal of the articles from the pallets or structure and then further handling and/or distribution of the articles. For purposes herein, the term pallet is utilized to refer to any load bearing structure that is suitable for supporting and carrying a load of articles, typically in a stack, thereon for storage and/or shipping of the articles. The standard pallet used in the shipping industry has an upper support surface on which the articles are stacked, a lower surface that rests on the ground or on another surface, and a gap between the upper and lower surface for receiving the tines of a forklift or like utility apparatus. The tines of the forklift are inserted in the gap to raise the pallet off of the ground and transport it to another location for storage, processing or transfer of the articles thereon. For ease of shipping and handling, various standard sizes and configurations for pallets are well known. The process of stacking articles on the pallet is commonly referred to as palletizing and the process of removing the articles from the pallet is commonly referred to as depalletizing. The terms palletizing and depalletizing refers generally to any stacking or unstacking process relative to articles that are placed on a pallet and the terms palletizer and depalletizer refers generally to apparatuses for performing such processes.

The articles delivered and/or stored on a pallet typically comprise packaged goods, such as products stored in cartons or other types of packaging containers, or empty containers for goods, such as crates and the like that receive goods therein. For efficiency purposes, the articles are usually stacked on the pallet in layers of such articles, typically with a plurality of articles making up each layer. An example of the use of a pallet system to deliver articles for handling and then further use is the delivery of a stack of plastic crates to a fruit or vegetable packing facility for filling with the produce. The stack of crates generally comprises a plurality of layers of crates on a pallet with each layer comprising a plurality of similarly sized and configured crates. After the stack of crates are delivered to the packing facility, the crates are removed from the pallet for distribution in the packing facility where they are filled with fresh produce for subsequent delivery to stores or other distribution centers. Typically, the crates are removed from the pallet (i.e., depalletized) by hand, which requires a significant amount of labor and generally increases the risk that the crates will be damaged or that someone will be hurt during the depalletizing process.

To speed up the depalletizing process and reduce the chances of damage or injury, various automated machines have been developed to remove the articles from the pallet without requiring human labor. As an example, U.S. Pat. No. 4,516,900 to Avey discloses a depalletizer that unloads articles from a pallet by tilting the pallet with a tilting mechanism so that the articles may be pushed off on to a discharge table by a pusher plate that has a protruding bar which engages the lower portion of the articles. U.S. Pat. No. 5,788,461 to Easton, et al. discloses an automatic depalletizer comprising a tilt bed which tilts a loaded pallet at a predetermined angle, a lift bed to raise the loaded pallet to the level of an exit conveyor, a back dam to exert a stop against a layer of articles to be removed and an endless collector belt to remove the entire layer of articles by applying a loading force against the articles. U.S. Pat. No. 5,971,700 to Heston discloses a pick and place depalletizer having a pallet carrier that moves a full pallet to a pallet site where a lift head is moved to engage the top layer of articles on the pallet and then move that layer to a different location. In one embodiment, the lift head is a vacuum lift head that comprises a plurality of orifices connected to a vacuum motor to engage the top layer by suction. U.S. Pat. No. 6,802,688 to Andersen, et al. discloses a depalletizer comprising a vertically displaceable lift head having a substantially horizontal suction face comprising a plurality of downwardly open suction chambers that engages the upper side of the upper layer of a stack of articles on a pallet. The foregoing depalletizers are examples of various types of apparatuses known in the art to remove articles from a pallet of such articles.

In general, many of the depalletizer apparatuses presently available or in use are somewhat complex and are not configured to handle sufficiently large quantities of pallets and articles to be beneficially utilized by those in the industry. What is needed, therefore, is a depalletizer that more effectively and efficiently removes articles that are stacked in layers on a pallet. The preferred depalletizer should be configured to receive a pallet stacked with a plurality of layers of articles and then remove a layer of the articles at one time to more quickly and efficiently depalletize the pallet. Preferably, the depalletizer should be configured to first separate the pallet from the stack of articles and then remove a layer of the articles from the bottom of the stack of articles. The preferred depalletizer will be able to direct the separated pallet in a direction different than the direction in which a layer of the articles are directed so that the pallet and articles may be efficiently handled or processed further. Preferably, the palletizer will be configured for a wide range of different types of articles and pallets.

### SUMMARY OF THE INVENTION

The off-the-bottom depalletizer apparatus and method of the present invention solves the problems and provides the benefits identified above. That is to say, the present invention discloses a depalletizer that is configured to receive a pallet having one or more layers of articles in a stack thereon and then remove a layer of articles from the stack. In a preferred embodiment of the present invention, the depalletizer receives a pallet full of articles into a separating chamber that engages the stack of articles, separates the pallet from the stack, transfers the empty pallet away, removes the bottom layer of articles from the stack and then empties the stack by incrementally removing the next lower layers of articles, thereby quickly and efficiently depalletizing the pallet. The preferred embodiment of the depalletizer of the present invention has a pallet transfer section that rapidly transfers away the empty pallet and an article transfer section that rapidly transfers away the articles removed from the stack of articles so that the pallet and articles may be further handled and/or processed. The depalletizer of the present invention is adaptable to a wide variety of pallets and articles.

In one general aspect of the present invention, the off-the-bottom depalletizer apparatus comprises a load receiving section having a pallet infeed conveyor that is configured to receive and transport a loaded pallet (i.e., a pallet having a stack of articles thereon in one or more layers) to a load separating section. The load separating section comprises a frame that defines a separating chamber having a clamping mechanism and a transfer mechanism therein. The clamping mechanism comprises a plurality of clamp members that are operatively connected to one or more air cylinders to move the clamp members between an open position in spaced apart relation to the stack and a clamping position in which the clamp members clamp against one or more layers of articles in the stack of articles. Other air cylinders are operatively connected to doors that are configured to open to allow a loaded pallet into the separating chamber and then close to place clamp members mounted thereon in position to clamp against the one or more layers of articles. A position monitoring device is utilized to determine when to open and close the doors. In the preferred embodiment, the transfer mechanism comprises a support structure having a support surface that is defined, alternatively and selectively, by a roller conveyor and a perpendicularly disposed chain conveyor. The chain conveyor is utilized to transport an empty pallet to a pallet transfer section comprising a discharge conveyor configured to transport the empty pallet to a location for storage or reuse. The roller conveyor is utilized to transfer a layer of articles from the stack to an article transfer section comprising an article take-away conveyor that delivers the articles for storage or further processing. A pneumatic system, comprising one or more air cylinders, is configured to move the support structure up and down inside the separating chamber and to move the chain conveyor up and down relative to the roller conveyor component of the support structure so as to alternatively utilize the chain conveyor or the roller conveyor to transport the pallet or layer of articles, respectively.

In operation, a loaded pallet is received in the receiving section and transported by the pallet infeed conveyor to the support structure in the separating chamber of the load separating section of the depalletizer. The clamping mechanism is activated to clamp the clamp members against at least the bottom layer, but preferably the bottom layer and at least one layer above, and support the stack above the bottom layer. A first air cylinder is operated to lower the support structure and, therefore, separate the pallet from the stack of articles and place it generally level with the discharge conveyor. The chain conveyor is operated to transport the pallet to the discharge conveyor, which is operated to transport the pallet away. The chain conveyor is then lowered, using a second air cylinder, below the level of the roller conveyor such that the roller conveyor defines the support surface. The support structure is then raised to the lower surface of the bottom layer of articles and the clamping mechanism is operated to place the clamp members in the open position, thereby transferring the stack to the support structure. The support structure, and the stack therewith, is then lowered a distance equal to the height of one layer of articles. The clamping mechanism is activated to clamp the layer of articles immediately above the bottom layer to support the stack above that layer. The support structure is then lowered to separate the bottom layer of articles from the stack. The roller conveyor is operated to transport the bottom layer of articles to the article take-away conveyor. The support structure is then raised to abut the new bottom layer of the stack, replacing the layer transported away, and the clamping mechanism is operated to place the clamp members in their open position and place the stack on the support structure. A portion of the above process is repeated until the stack is empty and then the entire process is repeated for a new loaded pallet.

Accordingly, the primary objective of the present invention is to provide an off-the-bottom depalletizer apparatus and method that has the advantages discussed above and overcomes the disadvantages and limitations associated with presently available depalletizers.

It is also an important object of the present invention to provide an off-the-bottom depalletizer apparatus and method that is configured to receive a loaded pallet comprising a stack of articles in layers and depalletize the pallet by removing the articles a layer at a time.

It is also an important object of the present invention to provide an off-the-bottom depalletizer apparatus and method that comprises a load receiving section for receiving a stack of articles on a pallet, a load separating section for separating the pallet from the articles and a layer of articles from the stack, a pallet transfer section that transfers the empty pallet and an article transfer section that transfers the articles.

It is also an important object of the present invention to provide an off-the-bottom depalletizer apparatus and method that depalletizes a pallet loaded with a stack of articles by separating the pallet from the stack of articles and then incrementally removing layers of articles from the bottom of the stack.

It is also an important object of the present invention to provide an off-the-bottom depalletizer apparatus and method that comprises a load separating section configured to separate layers of articles from a stack of such articles on a pallet by clamping the stack to separate the pallet therefrom and then incrementally clamping layers of the stack to remove the bottom layer therefrom.

It is also an important object of the present invention to provide an off-the-bottom depalletizer method that depalletizes a pallet loaded with a stack of articles by receiving the loaded pallet, delivering the loaded pallet to a load separating section, clamping the stack of articles at least at the lowest layer, separating the pallet from stack of articles, transporting away the empty pallet, raising a structure to the lower layer to support the stack, releasing the clamping, reclamping the stack above the lowest layer, removing the lower layer and then repeating the raising, releasing, reclamping and removing steps until the entire stack of articles is depalletized.

It is also an object of the present invention to provide an off-the-bottom depalletizer apparatus and that is adaptable to a wide range of different sizes of pallets and articles.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a side view of a depalletizer configured according to a preferred embodiment of the present invention showing loaded pallets in the load receiving and load separating sections;

FIG. 2 is a side view of the depalletizer of FIG. 1 showing the stack of articles clamped in the load separating section and the pallet separated from the stack;

FIG. 3 is a side view of the depalletizer of FIG. 2 showing the empty pallet moved to the pallet transfer section and the transfer mechanism raised to the bottom layer of the stack to support the stack with the stack unclamped;

FIG. 4 is a side view of the depalletizer of FIG. 3 showing the transfer mechanism lowered and the stack of articles reclamped above the bottom layer of articles;

FIG. 5 is a side view of the depalletizer of FIG. 4 showing the transfer mechanism further lowered to separate the bottom layer of the stack from the rest of the stack;

FIG. 6 is a side view of the depalletizer of FIG. 5 showing the separated layer of the stack conveyed away and the remaining layers of the stack supported above the clamped layer;

FIG. 7 is a side view of the depalletizer of FIG. 6 showing the stack unclamped and the transfer mechanism raised to the bottom of the remaining stack to repeat the process of removing a layer of articles from the stack;

FIG. 8 is a top view of the depalletizer of the present invention showing a loaded pallet in the load receiving section, a stack of articles in the load separating section, an empty pallet in the pallet transfer section and a separated layer of articles in the article transfer section;

FIG. 9 is a top view of the transfer mechanism utilized with the depalletizer of the present invention;

FIG. 10 is a side view of the transfer mechanism of FIG. 9 showing the chain drive mechanism in the up or raised position;

FIG. 11 is an end view of the transfer mechanism of FIG. 10;

FIG. 12 is a side view of the transfer mechanism of FIG. 9 showing the chain drive mechanism in the down or lowered position;

FIG. 13 is an end view of the transfer mechanism of FIG. 12; and

FIG. 14 is a flow chart summarizing the steps of the depalletizing process for the depalletizer of the present invention.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of a preferred embodiment and represents one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein are primarily described as being utilized with crates on a standard pallet, those skilled in the art will readily understand that this is merely for purposes of simplifying the present disclosure and that the present invention is not so limited, as the present invention is equally applicable for use with a variety of different types of articles and load bearing structures.

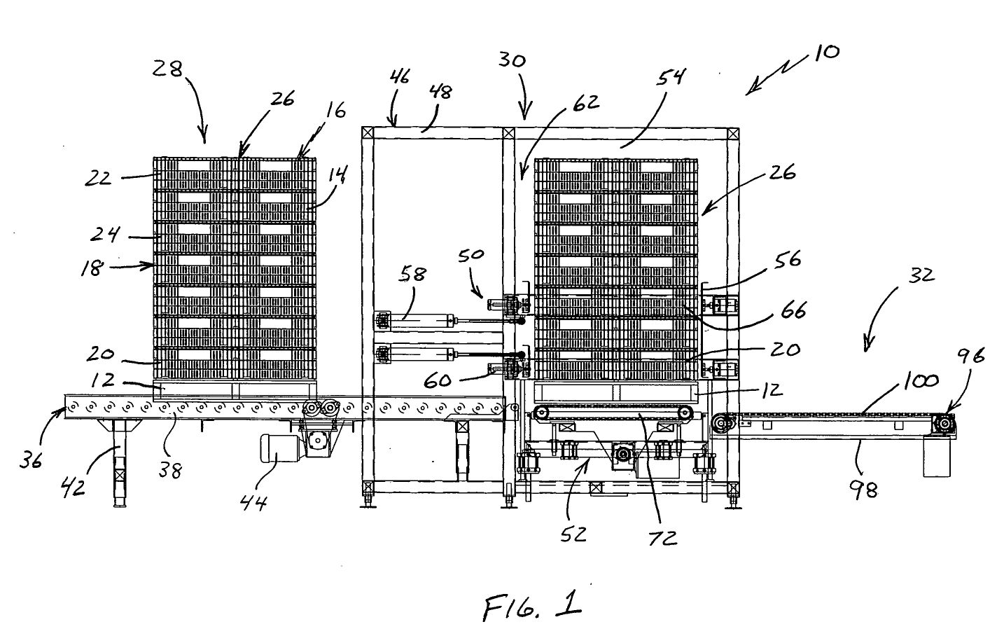

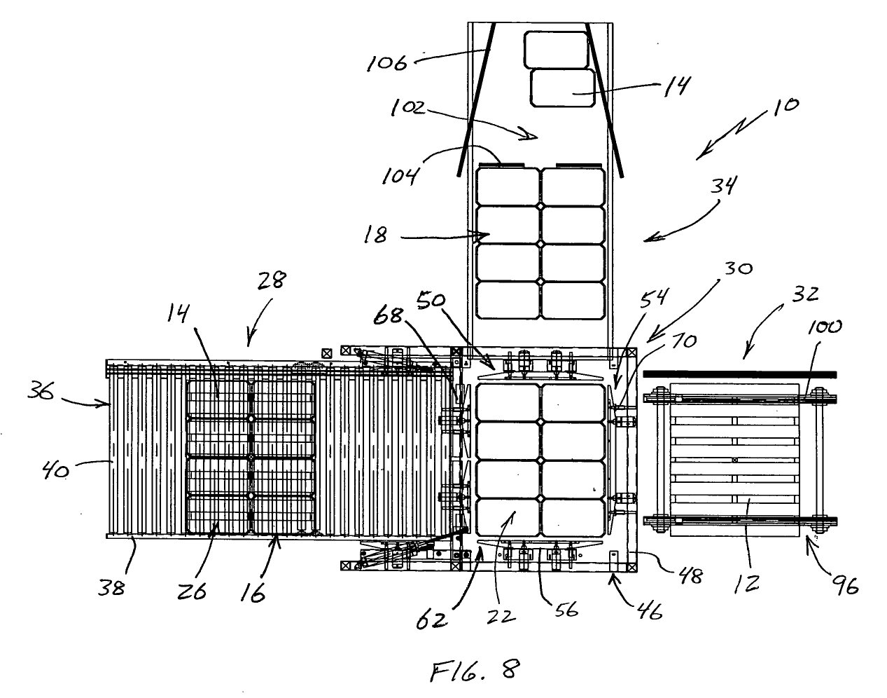

An off-the-bottom depalletizer that is manufactured out of the components and configured pursuant to a preferred embodiment of the present invention is shown generally as 10 in FIGS. 1 through 8. Depalletizer 10 is configured to receive a pallet 12 having a plurality of articles 14 configured as a stack 16 of such articles 14 having at least one layer 18. Typically, the stack 16 will have a plurality of layers 18 comprising a bottom layer 20, top layer 22 and a plurality of intermediate layers 24 therebetween. Collectively, the pallet 12 having a stack 16 of articles 14 thereon is referred to as a loaded pallet 26. As best shown in FIG. 8, depalletizer 10 of the present invention generally comprises a load receiving section 28 that receives the loaded pallet 26, a load separating section 30 that separates the pallet 12 from stack 16 and the layers 18 of articles 14 from stack 16, a pallet transfer section 32 that receives the unloaded or depalletized pallet 12 and transports it away, and an article transfer section 34 that receives the articles 14 removed from stack 16 and transports them away for further handling and/or processing. As will be explained in more detail below, the loaded pallet 26 is received at the load receiving section 28 and transferred to separating section 30 where pallet 12 is removed from stack 16 and, in an step-wise or incremental manner, lower layer 20 is removed from stack 16. Loaded pallet 26 moves into and through depalletizer 10 so that the individual articles 14 can be efficiently and quickly removed therefrom and pallet 12 emptied.

Load receiving section 28 has a pallet infeed conveyor 36 comprising an infeed conveyor structure 38 having a plurality of rollers 40 supported thereby, as best shown in FIG. 8. Infeed conveyor structure 38 is supported in spaced apart relation above the floor of the facility or ground by one or more support legs 42. A motor 44 is supported by infeed conveyor structure 38 and operatively connected to the rollers 40 such that when a loaded pallet 26 is placed on pallet infeed conveyor 36 the loaded pallet 26 will be conveyed to the adjacent load separating section 30. As will be readily apparent to those skilled in the art, various other conveying mechanisms or other mechanisms can be utilized to deliver loaded pallet 26 to load separating section 30. A continuous feed conveying system is preferred so that as soon as the loaded pallet 26 is depalletized in the load separating section 30, another loaded pallet 26 can be received therein for depalletizing.

As shown in FIGS. 1 through 8, load receiving section 30 comprises a frame 46 having a plurality of frame members 48, a clamping mechanism 50 supported by the frame 46 and configured to clamp onto one or more layers 18 of stack 16 and support the layers 18 above, and a transfer mechanism 52, also supported by frame 46, configured to support the loaded pallet 26 or stack 16 and to separate pallet 12 from stack 16 and convey it to pallet transfer section 32 and remove bottom layer 20 from stack 16 and transfer the articles 14 in bottom layer 20 to article transfer section 34. The frame members 48 of frame 46 define a separating chamber 54 in load receiving section 30 where the pallet 12 is separated from the stack 16 and the bottom layer 20 (which is always the lowermost layer in stack 16) is also separated from stack 16.

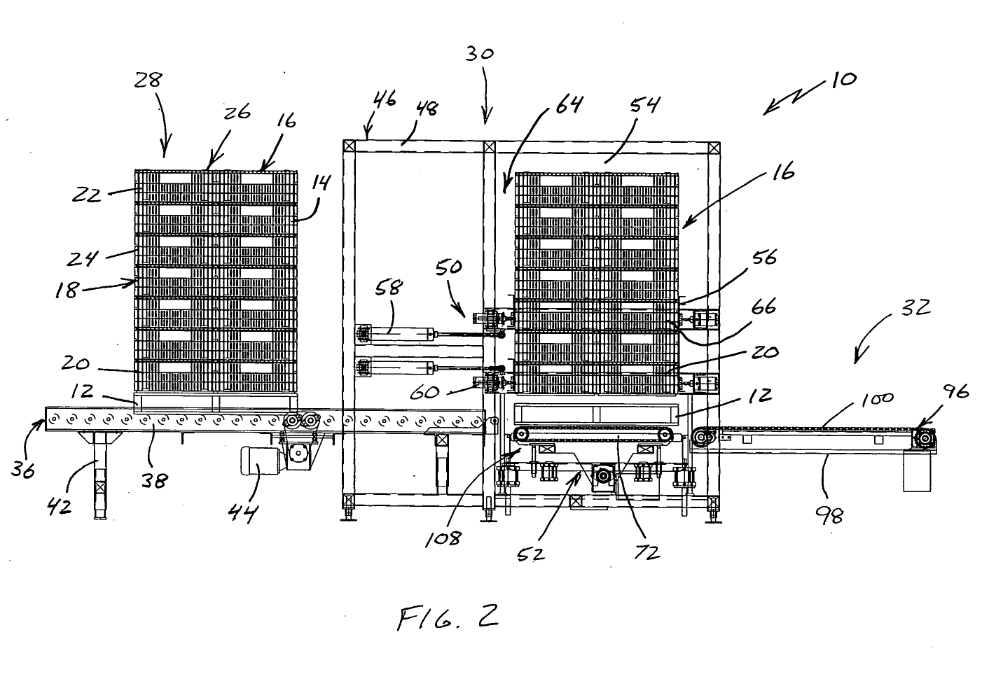

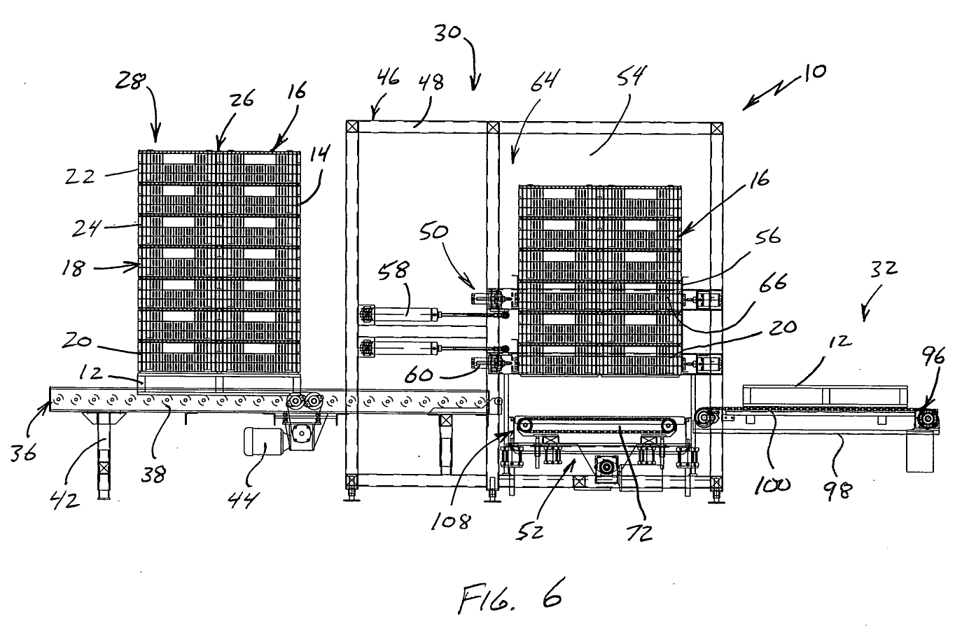

Clamping mechanism 50 is configured to clamp or squeeze against one or more layers 18 of stack 16 to hold stack 16 in a suspended position, such as shown in FIGS. 2 and 6. As such, clamping mechanism 50 must sufficiently clamp against layers 18 so that they do not fall when, as explained below, the pallet 12 or bottom layer 20 is removed. As a result, depalletizer 10 of the present invention can only be utilized with those articles 14 that have sufficient structural integrity that they form a layer 18 which can be tightly clamped and which is strong enough to support the layers, such as the top 22 and intermediate 24 layers, above the clamped layer. For example, crates or other containers commonly utilized to store and transport fresh fruit and vegetables generally have the characteristics that make them suitable for depalletizer 10 of the present invention. In a preferred embodiment, clamping mechanism 50 comprises a plurality of clamp members 56 operatively connected to clamp drive mechanism comprising a plurality of air cylinders 60 and pneumatic valves that are configured to move clamp members 56 between their open position 62, as shown in FIGS. 1, 3, 7 and 8, and their closed or clamping position 64, as shown in FIGS. 2 and 4 through 6. As well known in the art, a variety of different electrical, mechanical, pneumatic and other systems can be utilized as the clamp drive mechanism for clamping mechanism 50. Clamping mechanism 50 is configured to clamp one or more layers 18 of stack 16, including at least the bottom layer 20. In the embodiment shown in the figures, clamp members 56 of clamping mechanism 50 are configured to engage the bottom layer 20 and the second layer above the bottom layer 20, which are also referred to as the lower clamped layer, shown as 20 and the upper clamped layer 66. As explained in more detail below, the bottom layer 20 of stack 16 alternates between being a clamped layer and the bottom layer below the lower clamped layer for removal. Depending on the weight and structural integrity of the articles 14, it may only be necessary to clamp the bottom layer 20, if it is strong enough to support the above layers 18, or it may be necessary to clamp more than just two layers 18 in stack 16.

Clamping mechanism 50 can operate in a variety of different configurations. For instance, in one configuration all clamp members 56 can be operated to uniformly squeeze against the lower clamped layer 20 and the upper clamped layer 66. In a preferred embodiment, however, the clamp members 56 on the right and top sides of the stack 16 (relative to the bottom of the figure) are configured to move inwardly against stack 16 to square it up, thereby requiring these clamp members 56 to move only relatively small amount (i.e., one inch) to abut stack 16. In this embodiment, the clamp members 56 on the left and bottom sides of stack 16 move inwardly against stack 16 a distance sufficient to apply the desired amount of force to the one or more layers 18 to be clamped. The force imparted by these clamp members 56 (i.e., those on the left and bottom sides) is countered by the opposite clamp members 56 (i.e., those on the right and top sides) to engage one or more layers 18 of stack 16 therebetween. As explained in more detail below, clamping mechanism 50 is operated to allow the separation of pallet 12 from stack 16 and then bottom layer 20 from stack 16.

Air cylinders 58 are utilized to open and close doors 68 at the entrance to separating chamber 54 that is between load receiving section 28 and load separating section 30, as best shown in FIG. 8. Doors 68 support the clamp members 56 on that side of the separating chamber 54 and are utilized to allow the loaded pallet 26 to enter into the separating chamber 54. In the embodiment shown, a pair of doors 68 are utilized, each supporting a clamp member 56 and associated valving. The preferred embodiment also includes position monitoring device 70, such as an electric eye or the like, that is configured to detect when a loaded pallet 26 or a stack 16 is in separating chamber 54 and then send a signal to close doors 68. The position monitoring device 70 closes the doors 68 after loaded pallet 26 is received in separating chamber 54 and keeps the doors 68 closed until the last layer 18, which will be top layer 22, is removed from separating chamber 54 to the article transfer section 30, at which time doors 68 are opened to allow a new loaded pallet 26 to be received in separating chamber 54 for depalletizing.

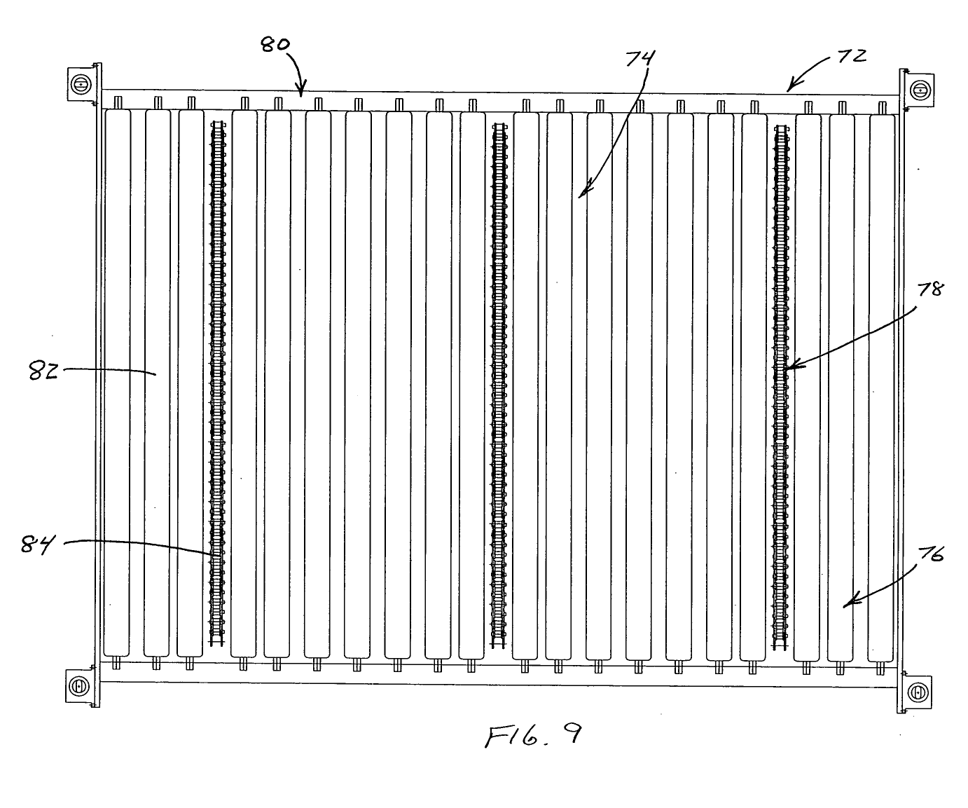

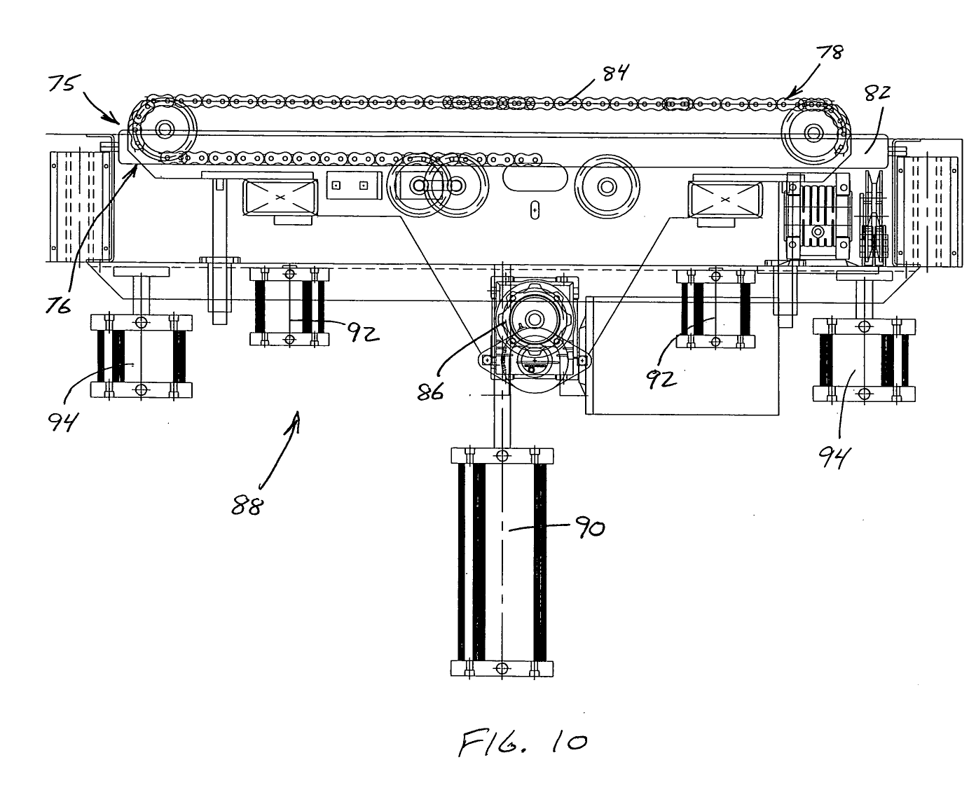

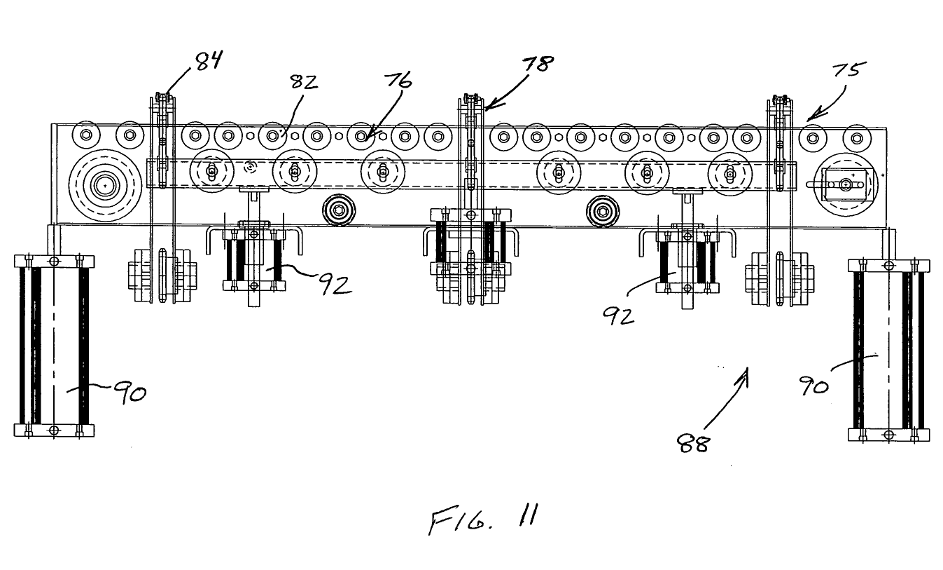

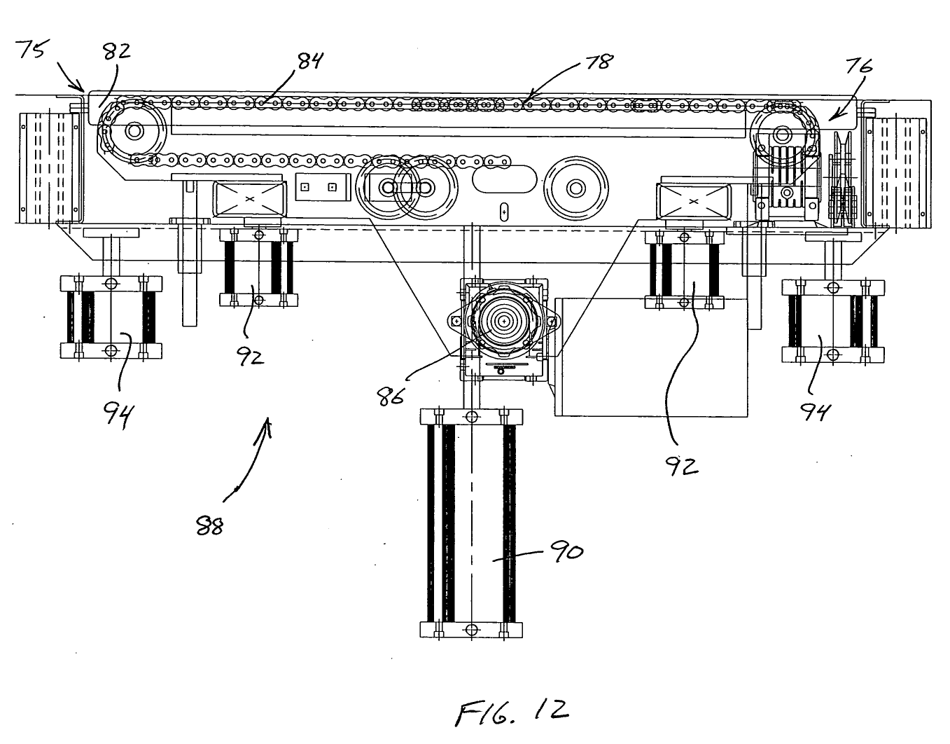

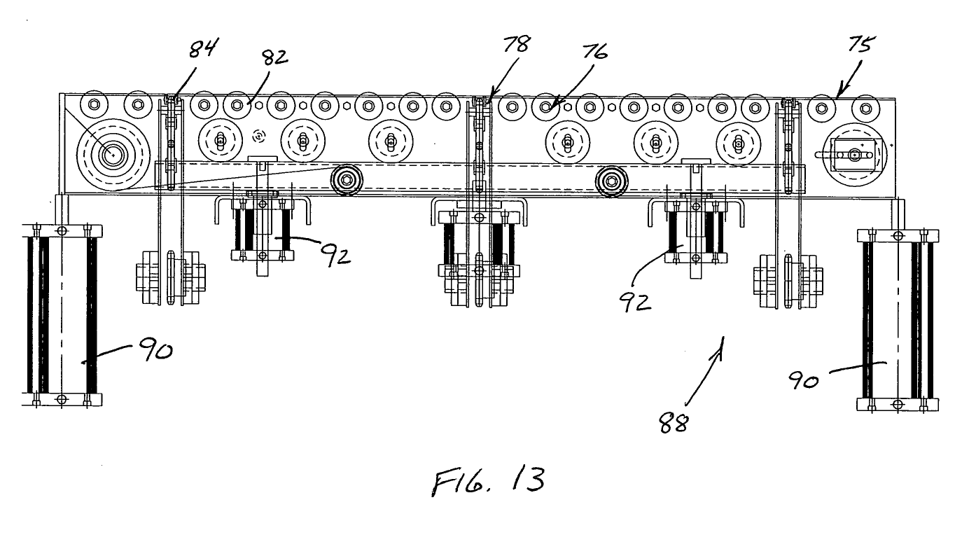

Transfer mechanism 52 is configured to separate the pallet 12 from the stack 16 of articles 14 and then to move the bottom layer 20 of stack 16 to article transfer section 34. In the preferred embodiment, as best shown in FIGS. 9 through 13, transfer mechanism 52 comprises a transfer support structure 72 having a support surface 74 and a discharging mechanism 75 configured to discharge the pallet 12 and the bottom layer 20 from load separating section 30, as explained below. Support surface 74 is defined, alternatively depending on the desired action by depalletizer 10, by a layer conveyor 76 or a pallet conveyor 78 that comprise discharging mechanism 75. In a preferred embodiment, as shown in the figures, layer conveyor 76 is a roller conveyor and pallet conveyor 78 is a chain conveyor. As explained in more detail below, transfer support structure 72 is moved up and down to contact either the lower surface of pallet 12 or the lower surface of bottom layer 20 to separate and move these components, using discharging mechanism 75, to their respective locations (i.e., pallet transfer section 32 or article transfer section 34). In addition, the pallet conveyor 78 is moved up and down relative to the layer conveyor 76 depending on whether contact is to be made with pallet 12 or bottom layer 20. These components are supported by a frame 80. As well known in the art, the roller conveyor of layer conveyor 76 comprises a plurality of rollers 82 and associated motor(s) and drive assemblies to rotate rollers 82 and the chain conveyor of pallet conveyor 78 comprises a one or more chains 84 and associated motor(s), such as the electric motor 86 shown in FIGS. 10 and 12, and drive assemblies to drive chains 84. To achieve the desired raising and lowering of support structure 72 and pallet conveyor 78, as described below, transfer mechanism 52 also comprises a structure moving mechanism 88, such as the pneumatic system shown. As best shown in FIGS. 10 and 12, the pneumatic system of structure moving mechanism 88 can comprises one or more first air cylinders 90 (two of which are shown in FIGS. 11 and 13) configured to raise and lower the entire support structure 72 of transfer mechanism 52, one or more second air cylinders 92 (two of which are shown in FIGS. 10 and 12) to raise and lower the pallet conveyor 78 relative to the layer conveyor 76, and one or more third air cylinders 94 (two of which are shown in FIGS. 10 and 12) to raise and lower the entire support structure 72 a relatively small amount to allow clearance for the pallet 12 to move to pallet transfer section 32 and the bottom layer 20 of stack 16 to move to article transfer section 34. The operation of the various air cylinders 90, 92 and 94 of pneumatic system 88 are explained below.

Pallet transfer section 32, shown in FIGS. 1 through 8, is utilized to receive an depalletized pallet 12 and transfer it away for storage or further use (i.e., to receive articles thereon). In a preferred embodiment, pallet transfer section 32 comprises a discharge chain conveyor 96 supported by a transfer section frame 98 and comprising a chain 100. Discharge chain conveyor 96 is fixed, meaning it does not move up and down, but it is positioned at a level lower than the level of pallet infeed conveyor 36 for ease of operation with regard to the removal of pallet 12 after it has been separated from stack 16 by transfer mechanism 52. In one embodiment, discharge chain conveyor 96 is two inches lower than pallet infeed conveyor 36. As explained below, transfer mechanism 52 lowers support structure 72, using third air cylinder 94, to the level of the discharge chain conveyor 96.

Article transfer section 34, shown in FIG. 8, is utilized to receive articles 14 removed from the stack 16, typically in a layer 18, by transfer mechanism 52. In a preferred embodiment, article transfer section 34 comprises an article take-away conveyor 102 that is configured to receive an entire layer 18 of articles 14 from stack 16, a pair of stops 104 configured to selectively stop one of the rows of the layer 18 and let the other proceed for further processing and a chute 106 for directing the row of articles 14 in the desired direction. For use with crates having material therein, the articles 14 would proceed to a dump station (not shown) that dumps the materials out of the articles 14 and then to a stacking station that stacks the articles for reuse. If two dump stations are utilized, it will generally not be necessary to provide stops 104 as both rows of articles 14 can proceed to the dump stations. In a preferred embodiment, article take-away conveyor 102 is fixed at the same height as the discharge chain conveyor 96, which is slightly lower (i.e., two inches) than the pallet infeed conveyor 36 so that the bottom row 20 of stack 16 can be separated from stack 16 and the more easily transferred to article take-away conveyor 102. As explained below, transfer mechanism 52 lowers support structure 72, using third air cylinder 94, to the level of the article take-away conveyor 102.

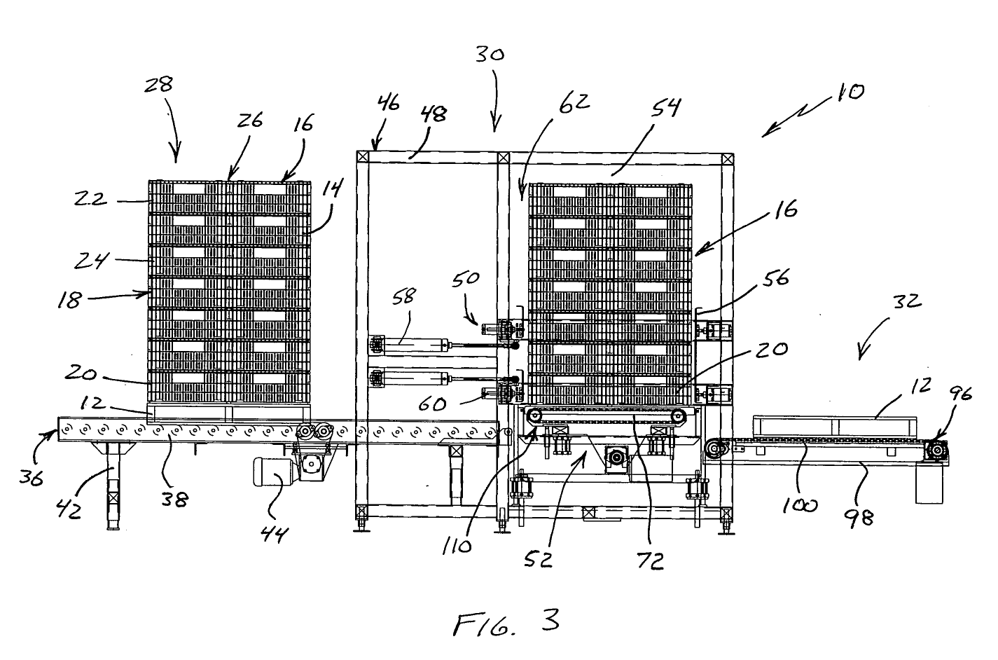

The operation of the depalletizer 10 of the present invention is shown sequentially in FIGS. 1 through 7. In FIG. 1, the loaded pallet 26 is received in load receiving section 28 on pallet infeed conveyor 36, which conveys loaded pallet 26 to the load separating section 30. If there is not a loaded pallet 26 or stack 16 in separating chamber 54, as determined by position monitoring device 70, then the doors 68 are open to allow a loaded pallet 26 to be received in the separating chamber 54, as shown in FIG. 1, and then the doors 68 are closed. Prior to receiving loaded pallet 26 in separating chamber 54, first air cylinder 90 of pneumatic system 88 places the support surface 74 of support structure 72 approximately at the same level, or slightly below, as the pallet infeed conveyor 36, with the pallet conveyor 78 defining support surface 74, as shown in FIGS. 10 and 12 with chain 84 in its up position. In FIG. 1, the bottom of pallet 12 is abuts and is supported by the pallet conveyor 78 of support structure 72. With loaded pallet 26 supported by support structure 72, the clamping mechanism 50 is activated so that clamp members 56 are engaged to move to their clamping position 64, as shown in FIG. 2, to abut a portion of stack 16. In the embodiment of FIG. 2, clamp members 56 engage the bottom layer 20 of stack 16 and the upper clamped layer 66. With stack 16 secured in place by clamping mechanism 50, third air cylinder 94 is activated to lower support structure 72 to a lowered position 108, which at this point in the process is the set amount (i.e., two inches) such that the bottom of pallet 12, which moves down with support structure 72 because it is not held in place by clamping mechanism 50, is substantially aligned with discharge conveyor 96. The pallet conveyor 78 of support structure 72 is activated to move pallet 12 to the discharge conveyor 96, as shown in FIG. 3, so that pallet 12 can be transferred for storage or reuse. Once pallet 12 is removed, second air cylinder 92 is activated to lower pallet conveyor 78 below the layer conveyor 76 such that the roller conveyor forms support surface 74. As also shown in FIG. 3, support structure 72 is raised by first air cylinder 90 to its raised position 110 such that support surface 74, defined by the layer conveyor 76, abuts the lower surface of bottom layer 20. With support structure 72 in its raised position 110 below bottom layer 20, the clamping mechanism 50 is activated to move clamp members 56 to their open position 62, as shown in FIG. 3, to transfer stack 16 to support structure 72.

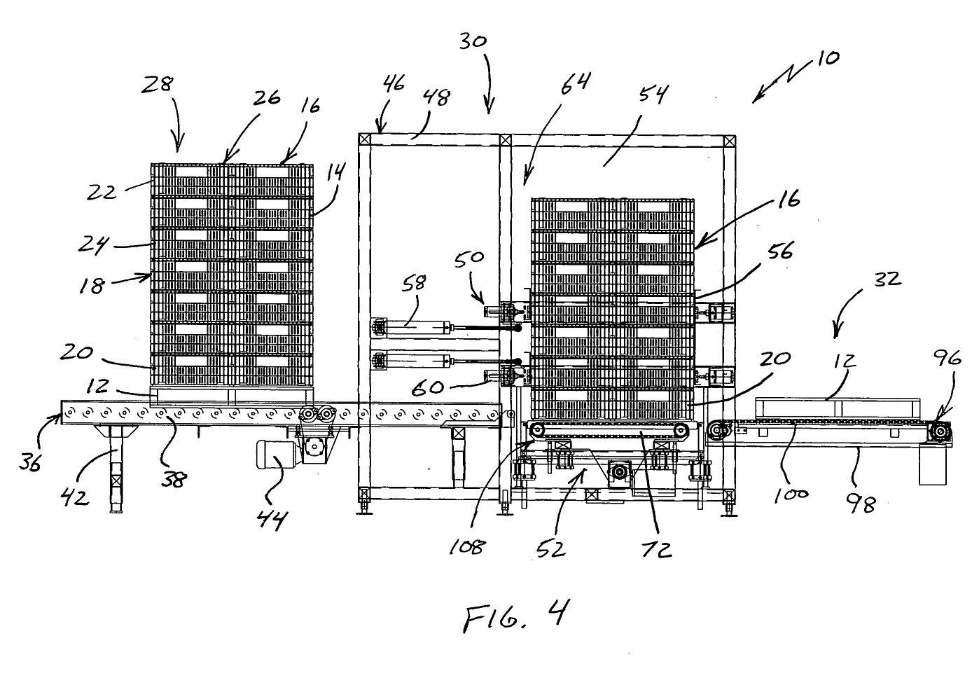

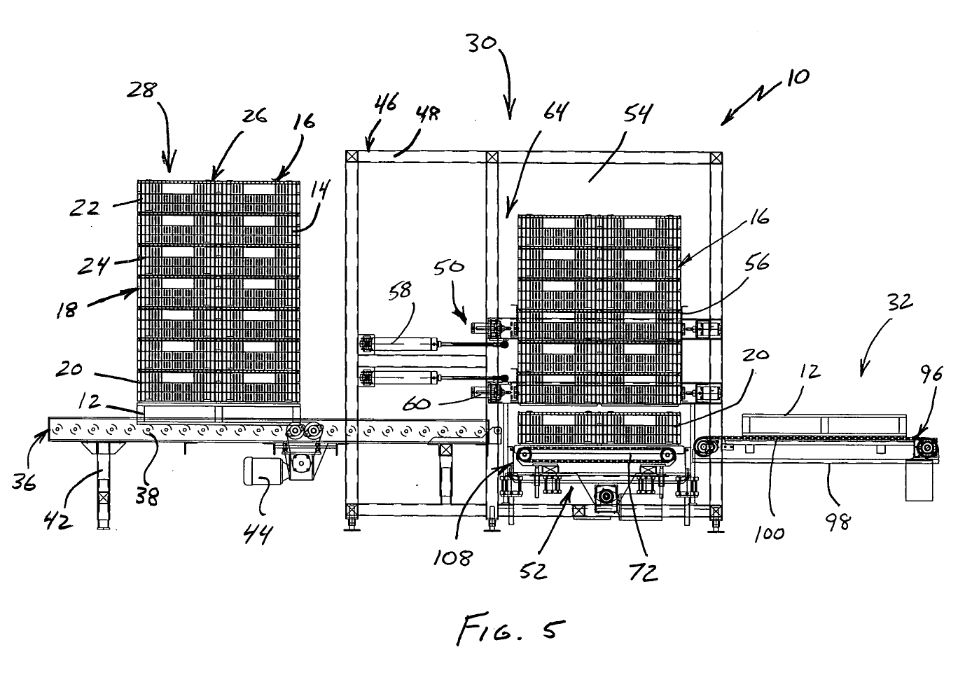

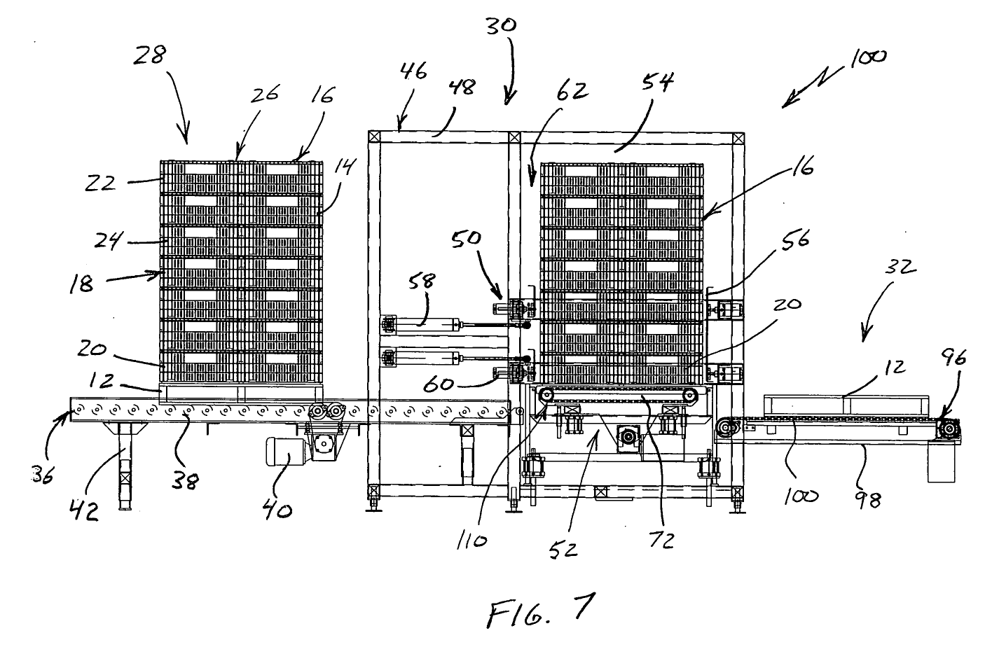

In FIG. 4, the support structure 72 is shown having been lowered to a lowered position 108, in this case approximately the height of one layer 18 of articles 14 by first air cylinder 90, thereby lowering stack 16, so that the clamp members 56 of clamping mechanism 50 will engage the layer 18 above the bottom layer 20 and the layer 18 two layers above, making these layers the lower clamped layer 20 and upper clamped layer 66, respectively. With the clamp members 56 in their clamping position 64, thereby transferring the weight of stack 16 above the bottom layer 20 to the clamping mechanism 50, third air cylinder 94 is activated to lower support structure 72 to another lowered position 108, which is the specified amount (i.e., two inches), as shown in FIG. 5, to substantially align layer conveyor 76 of support surface 74 with the article take-away conveyor 102. The activation of layer conveyor 76 transfers the bottom layer 20 to article take-away conveyor 102, as shown in FIG. 8, to leave the remaining portion of stack 16 being supported by the clamping mechanism 50 in spaced apart relation to the support surface 74 of support structure 72, as shown in FIG. 6. First air cylinder 90 is activated to move support structure 72 upward to its raised position 110 so the support surface 74 will abut against the lower surface of bottom layer 20, as shown in FIG. 7. As also shown in FIG. 7, clamping mechanism 50 moves clamp members 56 to their open position 62 to transfer the stack 16 to support structure 72. Once the stack 16 is on support structure 72, the process described above in conjunction with that shown in FIGS. 4 through 7 is repeated until the top layer 22 of stack 16 is transferred to article take-away conveyor 102. Once the position monitoring device 70 determines that separating chamber 54 is empty, doors 68 will be activated to open and allow another loaded pallet 26 to move into separating chamber 54 so that it can be depalletized as described above. Using the depalletizer 10 and method of the present invention, the inventor has achieved depalletizing speeds of 3,500 boxes an hour.

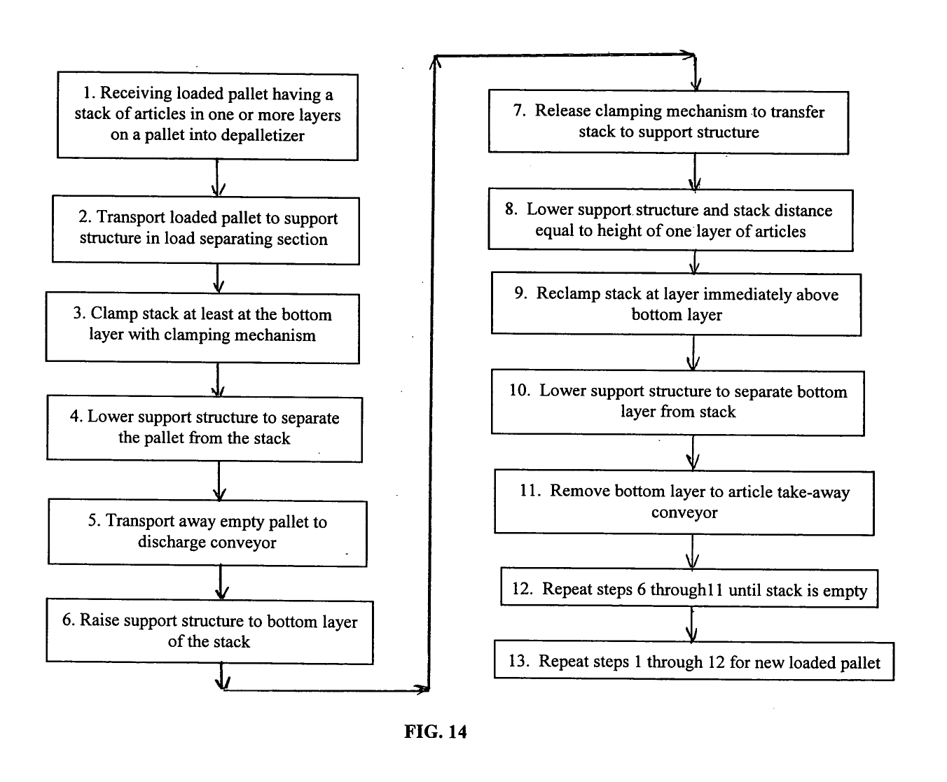

The method of the depalletizing according to the present invention using depalletizer 10 is summarized in the flow chart of FIG. 14. As shown therein, depalletizing loaded pallet 26 comprises the following steps (1) receiving a loaded pallet 26 at a load receiving section 28; (2) transporting the loaded pallet 26 to a support structure 72 in a load separating section 30; (3) clamping the stack 16 of articles 14 with a clamping mechanism 50 at least at bottom layer 20; (4) lowering the support structure 72 to separate the pallet 12 from the stack 16 of articles 14; (5) transporting away the empty pallet 12 to a discharge conveyor 96; (6) raising the support structure 72 to the lower surface of the bottom layer 20 to support the stack 16 thereon; (7) releasing the clamping mechanism 50 to transfer stack 16 to support structure 72; (8) lowering support structure 72 and stack 16 a distance equal to the height of one layer 18 of stack 16; (9) reclamping stack 16 at the layer immediately above bottom layer 20; (10) lowering support structure 72 to separate bottom layer 20 from the remaining portion of stack 16; (11) removing bottom layer 20 to article take-away conveyor 102; (12) repeating the raising, releasing, lowering, reclamping, lowering and removing steps of steps 6 through 11 until entire stack 16 of articles 14 is depalletized; and (13) repeating steps 1 through 12 for a new loaded pallet 26 until all such loaded pallets 26 have been depalletized.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A depalletizer for removing articles from a stack of articles on a pallet, said depalletizer comprising:
a load separating section for receiving a loaded pallet;
means associated with said load separating section for clamping at least one layer of said stack of articles to define a clamped layer, said clamping means configured to support said clamped layer and said stack of articles above said clamped layer;
means associated with said load separating section for separating said pallet or a bottom layer from said stack of articles below said clamped layer;
means associated with said load separating section for selectively discharging said pallet or said bottom layer out of said separating section after separation from said stack of articles;
a pallet transfer section for receiving said pallet after separation from said stack of articles; and
an article transfer section for receiving said bottom layer after separation from said stack of articles.

2. The depalletizer according to claim 1, wherein said clamping means comprises one or more clamp members operatively connected to a clamp drive means for moving said clamp members between an open position and a clamping position.

3. The depalletizer according to claim 1, wherein said separating section comprises a support structure moveably disposed therein and means for moving said support structure between a raised position generally abutting said pallet or said bottom layer and a lowered position for receiving said loaded pallet thereon and for separating said pallet or said bottom layer from said stack of articles.

4. The depalletizer according to claim 3, wherein said separating section further comprises a frame defining a separating chamber, said support structure disposed in said separating chamber.

5. The depalletizer according to claim 3, wherein said support structure comprises a support surface selectively defined by a pallet conveyor or a layer conveyor.

6. The depalletizer according to claim 5, wherein said moving means is further configured to move said pallet conveyor above said layer conveyor for engagement with said pallet.

7. The depalletizer according to claim 1, wherein said discharging means comprises a pallet conveyor for discharging said pallet and a layer conveyor for discharging said bottom layer.

8. The depalletizer according to claim 1, wherein said pallet transfer section comprises a discharge conveyor for receiving and transporting said pallet.

9. The depalletizer according to claim 1, wherein said article transfer section comprises an article take-away conveyor for receiving and transporting said articles in said bottom layer.

10. A depalletizer for removing articles from a stack of articles on a pallet, said depalletizer comprising:
a pallet infeed conveyor to move a loaded pallet to a load separating section;
means associated with said load separating section for clamping at least one layer of said stack of articles to define a clamped layer, said clamping means configured to support said clamped layer and said stack of articles above said clamped layer;
a support structure moveably disposed in said separating section;
means for moving said support structure between a raised position generally abutting said pallet or a bottom layer and a lowered position for receiving said loaded pallet thereon and for separating said pallet or said bottom layer from said stack of articles;
means associated with said load separating section for selectively discharging said pallet or said bottom layer away from said separating section after separation from said stack of articles;
a pallet transfer section for receiving said pallet after separation from said stack of articles, said pallet transfer section having a discharge conveyor for receiving and transporting said pallet; and
an article transfer section for receiving said bottom layer after separation from said stack of articles, said article transfer section having an article take-away conveyor for receiving and transporting said articles in said bottom layer.

11. The depalletizer according to claim 10, wherein said clamping means comprises one or more clamp members operatively connected to a clamp drive means for moving said clamp members between an open position and a clamping position.

12. The depalletizer according to claim 10, wherein said support structure comprises a support surface selectively defined by a pallet conveyor and a layer conveyor.

13. The depalletizer according to claim 12, wherein said moving means is further configured to move said pallet conveyor above said layer conveyor for engagement with said pallet.

14. The depalletizer according to claim 10, wherein said discharging means comprises a pallet conveyor for discharging said pallet and a layer conveyor for discharging said bottom layer.

15. A method of depalletizing articles from a stack of articles having a one or more layers on a pallet, said method comprising the steps of:
a. Receiving a loaded pallet on a support structure in a load separating section of a depalletizer;
b. Clamping a bottom layer of said stack of articles to support said stack of articles above said pallet;
c. Lowering said support structure to separate said pallet from said stack of articles;
d. Transporting away said pallet;
e. Raising said support structure to abut said bottom layer of said stack of articles;
f. Unclamping said bottom layer;
g. Lowering said support structure and said stack of articles the height of one layer of said articles;
h. Clamping a layer of said stack of articles above said bottom layer to support said stack of articles above said bottom layer;
i. Lowering said support structure to separate said bottom layer from said stack of articles;
j. Transporting away said bottom layer; and
k. Repeating steps e through j until said stack of articles is removed from said load separating section.

16. The method according to claim 15, wherein said depalletizer comprises means for clamping at least one of said one or more layers of said stack of articles, said clamping means having one or more clamp members operatively connected to a clamp drive means for moving said clamp members between an open position and a clamping position.

17. The method according to claim 15, wherein said separating section comprises means for moving said support structure between a raised position generally abutting said pallet or said bottom layer and a lowered position for receiving said loaded pallet thereon and for separating said pallet or said bottom layer from said stack of articles.

18. The method according to claim 15, wherein said pallet and said bottom layer transporting steps are accomplished by means associated with said load separating section for selectively discharging said pallet or said bottom layer out of said separating section after separation from said stack of articles.

19. The method according to claim 18, wherein said discharging means comprises a pallet conveyor for discharging said pallet and a layer conveyor for discharging said bottom layer.

20. The method according to claim 15, wherein said depalletizer further comprises a pallet transfer section and an article transfer section, said pallet transfer section having a discharge conveyor for receiving said pallet transported away in step (d), said article transfer section having an article take-away conveyor for receiving said bottom layer transported away in step (k).
